(19) United States
(12) Patent Application Publication
(10) Pub. No.: US 2006/0224499 A1
(43) Pub. Date: Oct. 5, 2006

(54) Method and apparatus for computing a loan quality score

(75) Inventors: Benjamin Graboske, Trabuco Canyon, CA (US); Vernon Martin, Los Angeles, CA (US)

Correspondence Address: SNELL & WILMER LLP, 600 ANTON BOULEVARD, SUITE 1400, COSTA MESA, CA, 92626, US

(73) Assignee: First American Real Estate Solutions, L.P.

(21) Appl. No.: 11/093,119

(22) Filed: Mar. 29, 2005

(51) Int. Cl. G06Q 40/00

(52) U.S. Cl. 705/38

(57) ABSTRACT

A method of computing a loan quality score using user input data concerning a subject property and the proposed loan, The loan quality score is useful in determining the probability that fraud is involved in the property loan request being made to a lender.

### BACKGROUND

1. Field of the Invention

The present invention relates to loan valuation and more specifically to a method and apparatus for computing a loan quality score for property loans. A loan quality score may be used by a lender in determining whether or not to issue or purchase a loan on a particular property.

2. Background of the Invention

There exists a need in the loan industry for objective criteria to determine the likelihood that a loan may not be repaid due to fraudulent misrepresentation of the collateral. Determining this accurately in a rapidly growing or fluctuating property market is only more difficult. Many times the appraisal supporting the loan application for a particular property is either inaccurate, exaggerated or an outright attempt at loan fraud. As a result, a lender on a particular property, either for a home purchase loan or for a mortgage on a home, would like to have some valuable indicator of the likelihood that a loan fraud is about to occur. A method is needed whereby a lender may evaluate the accuracy and validity of a particular loan request and to provide ready access to the information that evaluation is based upon for each target property.

It is therefore an object of the present invention to provide a means by which the quality of a loan and the valuation for the property being given may be tested for validity and accuracy. It is another object of the present invention to use numerous variables to provide as accurate a loan quality score as possible for use by a lender for a loan on a residential or other property.

### SUMMARY OF THE INVENTION

A method and apparatus for computing a loan quality score using numerous metrics that have been found to relate to the likelihood of property overvaluation or loan fraud. The present invention collects relevant data, either from automated valuation models, publicly available records or other sources, performs calculations based upon that data and then provides a comprehensive loan quality score. In the preferred embodiment, details of the data used to create the loan quality score are also provided.

### BRIEF DESCRIPTION OF THE DRAWINGS

FIG. 1 is a depiction of an example data structure used to implement the invention.

FIG. 2 is a flowchart of the steps involved in the creation of a loan quality score.

FIG. 3a is a table depicting the values of the variables and calculations used in an example loan quality score generation.

FIG. 3b is a table depicting the calculation of the Loan Quality Score using the Logit from FIG. 3a.

FIG. 4a is a table depicting the values of the variables and calculations used in another example loan quality score generation of the preferred embodiment.

FIG. 4b is a table depicting the calculation of the Loan Quality Score using the Logit from FIG. 4a.

### DETAILED DESCRIPTION OF THE INVENTION

The present invention provides a method and apparatus for computing a loan quality score for a loan on a residential or other property. Because the loan industry is one in which numerous loan applications must be quickly approved or denied based upon limited knowledge of the subject property being lent upon, a method is needed by which the sufficiency and validity of the collateral for the loan may be evaluated. This invention addresses that need by calculating a loan quality score, based upon numerous criteria. The loan quality score is calculated in different ways if particular information is missing for a subject property. In the preferred embodiment, the data upon which the quality score is based is also provided.

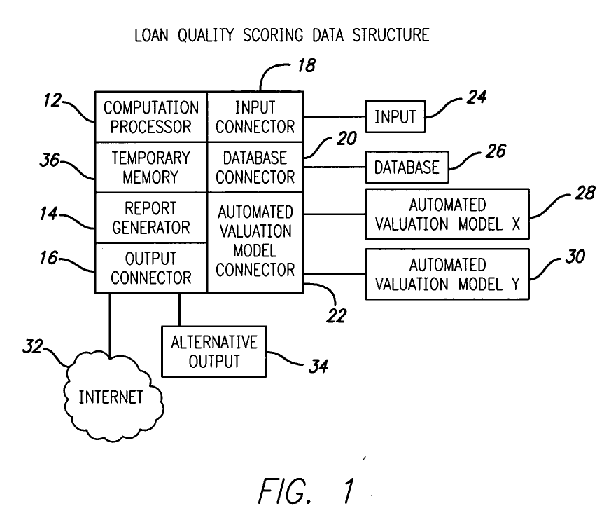

Referring first to FIG. 1, an example data structure used to implement the invention is depicted. This data structure is typically implemented using software on a standard personal computer or server. It may be implemented on other types of computers, including mainframe computers, server clusters, handheld computers or laptops. In the preferred embodiment a typical personal computer server is used. However, in alternative embodiments, the data structure depicted herein or a similar data structure used to accomplish the method of this invention may be employed by hard-wiring or hard-coding the software into a computer, such that the computer performs only one function, that of the method described herein.

The computation processor 12 is responsible for performing the calculations associated with applying the algorithms used to calculate the loan quality score to the data. The temporary memory 36 is used to store the variables as used in the equation and other temporary data prior to use or output. The report generator 14 is used to format the data into a report as described below. The output connector 16 is used to connect the loan quality scoring data structure to outside output methods. This could include connections to the Internet 32, typically using traditional means such as output to a dynamically generated webpage. There may also be alternative output 34 such as output of the report or loan quality score to a fax machine or other output device.

The input connector 18 receives input 24 from a keyboard, a mouse, the internet or any number of other input devices. The database connector 20 connects the loan quality scoring data structure to various databases 26. The automated valuation model connector 22 connects the loan quality scoring data structure to any number of automated valuation models (commonly referred to as AVMs), such as automated valuation models X in element 28 and Y in element 30. These are used to gather value estimations for the target properties that the loan quality score is being generated.

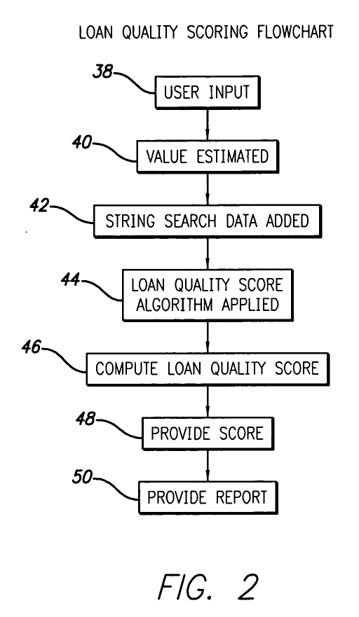

Referring next to FIG. 2, a flowchart depicts the steps in the preferred embodiment of the loan quality score creation. In the preferred embodiment, the process begins with user input step as depicted in element 38. Some of the suggested user input data requested in the preferred embodiment are the address of the target property, the requested loan amount, the estimated property value, the lien type requested, and the seller's name. Each of the inputs in the preferred embodiment are described below. The estimated property value will already be known to the user as a result of a direct on-site appraisal or a purchase contract. Alternatively, the user may input a value that is believed to be close to the value of the target property. This data will be used in collecting additional data and in calculating and providing a loan quality score.

In the preferred embodiment, the next step in the loan quality scoring process is to estimate the value using a particular automated valuation model. This step is shown in element 40 of FIG. 2. If the user input data includes an automated valuation model valuation in the step depicted in element 38 above, the automated valuation model used in this step should be different from the one used previously. This provides an additional safety check to ensure an accurate loan quality score. Typical AVMs use complex mathematics and statistical data to provide valuations of properties using their address. Generally, size and type of the properties are also considered, along with the location and additional data available from nearby comparable sales in the recent past. This value is appended to the data set provided by user input. In alternative embodiments, the invention may be practiced without the user's estimate of value if it is missing, or alternate inputs may be used. In such alternative embodiments, the loan quality score would be calculated using a similar but different equation from the one described below.

Next, in one embodiment, the loan score computation method searches the user input of the seller name(s) for certain key words known to correlate with loan fraud. This is also known as a “string search.” This step is depicted in element 42 in FIG. 2. The seller's name as input by the user and sets a binary variable (also commonly known as a “dummy” variable) if the seller of the property has certain characteristics known to correlate with loan fraud. A binary variable 1 signifies a true and 0 signifies a false. Sellers who fall into this category are flagged as risky. The usage of this binary variable will be described below. The data concerning the seller, if it exists is then added to the user input and stored. In alternative embodiments, this step may be altered or removed altogether. However, this data has been shown to provide valuable information concerning the likelihood of fraud on a particular loan.

In the preferred embodiment, the next step is to apply the loan quality score algorithm as depicted in element 44. The algorithm utilizes several variables. They are as follows:

| | | |
|---|---|---|
| 1 | RS | Whether the seller is considered to be risky |
| 2 | TS | The number of times the subject property has been |
| | | sold during a predetermined period of time, such |
| | | as the last two years |
| 3 | RF | Whether the loan is a purchase or a refinance |
| 4 | AO | Whether the purchaser intends to occupy the |
| | | subject property upon purchase |
| 5 | AVM | An AVM valuation of the subject property |
| 6 | EX | Whether the user-submitted value exceeds the AVM |
| | | valuation |
| 7 | EX50 | Whether the user-submitted value exceeds the AVM |
| | | valuation by a predetermined value or percentage, |
| | | such as 50% |
| 8 | NARM | Whether the transaction appears to not be at arm's |
| | | length, such as if the transaction appears not to |
| | | be between family members or individuals with the |
| | | same name |
| 9 | AG | The age of the subject property in years |
| 10 | LA | The requested loan amount |
| 11 | US | The user submitted value of the subject property |
| 12 | SF | The size of the subject property in square feet |

The algorithm in this embodiment also considers the ratio of user-submitted value, US, to the AVM valuation, AVM. An algorithm is applied using these variables. This algorithm is as follows:

$$\begin{matrix}Logit = 0.534 * RS \\ + 0.637 * TS \\ - 0.984 * RF \\ + 0.979 * AO \\ - 0.00000808 * AVM \\ + 1.278 * EX \\ + 1.301 * EX 50 \\ + 0.907 * NARM \\ + 0.029 * AG \\ + 0.0000136 * LA \\ + 109139 / AVM \\ + 0.653 * ( US / AVM ) \hat{} 2.25 \\ - 0.000596 * SF \\ - 3.738\end{matrix}$$

Where:

Logit is the natural logarithm of the odds ratio, namely p/(1−p), where P is the probability that the loan is fraudulent.

RS is the risky seller binary dummy variable. If the seller is risky, then the binary variable is set to 1. If the seller is not risky, then the binary variable is set to 0.

TS is the number of times the property has been sold in the past three years.

RF is a binary dummy variable for refinance loans. If the loan is a refinance, the binary variable is set to 1, otherwise it is set to 0.

AO is a binary dummy variable for absentee owner. If the purchaser does not intend to live in the subject property after purchase, this binary variable is set to 1, otherwise it is set to 0.

AVM is the automated valuation model's estimate of value.

EX is the binary dummy variable when user-submitted value exceeds automated valuation model valuation. If the user-submitted value exceeds the automated valuation, this binary variable is set to 1, otherwise it is set to 0.

EX50 is the binary dummy variable when user-submitted value exceeds automated valuation model valuation by 50% or more. If the user-submitted value exceeds the automated valuation by 50% or more, this binary variable is set to 1, otherwise it is set to 0.

NARM is the binary dummy variable for a non-arm's length transfer. If the sale appears to not be at arms length, that is, between family members or individuals of the same name, then this binary variable is set to 1, otherwise it is set to 0.

AG is the age of the target property.

LA is the loan amount.

AV is the appraised value.

US is the user-submitted value.

SF is the square footage of the target property.

Each of these variables are derived, either directly from the user input or by examining data in a database collected over time which includes known fraudulent loan requests. Also, some variables are included after calculating their relevance based upon the user input data or database data. The entire equation has been derived using techniques designed to take each variable selected into account and has found that the coefficients associated with them provide the most accurate representation of their relevance in predicting potential loan fraud.

The equation used in this and in the preferred embodiment and are derived using a sample set of fraudulent and non-fraudulent loan data. Statistical analysis is used to derive the above equation and it has been found to be the best mode. However, alternative equations may exist and may be used. In alternative embodiments of this invention, one or more of the required variables listed above may not be available or the user may not input them. In these cases, a different equation is used, one derived using statistical analysis without the variable or variables that are unavailable. In another alternative embodiment, additional variables or fewer variables will be included. Additional statistical analysis will be required to derive an equation for each group of data used to predict fraudulent loan applications.

Once the Logit is computed, the loan quality score is computed, as depicted in element 46, by multiplying the Logit, as computed above, and a predetermined constant and then subtracting that result from another constant. In this embodiment, these two constants are determined by comparing scores produced using the present invention with scores produced for loans known to be fraudulent and using statistical analysis to derive the correct constants. In this embodiment, the following equation is used to compute the loan quality score:
Loan Quality Score=500−(33*Logit)

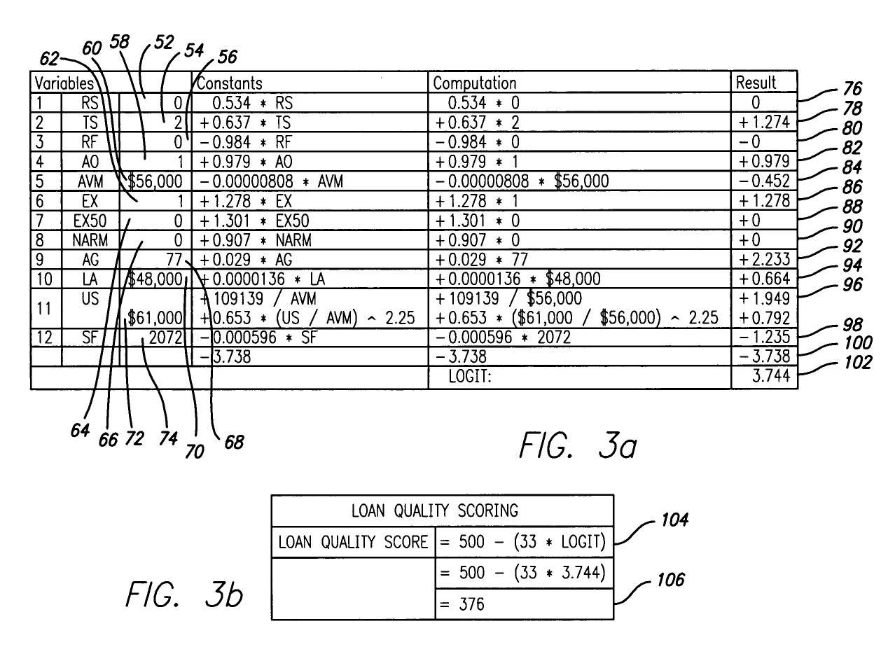

Referring now to FIG. 3a, using these equations, an example interaction is depicted. In this theoretical sale, a loan is requested by an individual Bill Buyer. An individual named Sally Seller is the home seller. The sale price is $61,000 for a 2,072 square foot home that is seventy-seven years old. The AVM valuation of that home is $56,000 and the requested loan amount is $48,800. This is a purchase and the buyer does not intend to live in the home after purchase. The seller is not known to be of a risky type. A risky seller, in this embodiment of the invention would be a seller whose name, when a string search is performed on the name, included the words: “trust,” “llc,” “investment,” “rent” or “marketing.” These words in the seller's name have been highly correlated to instances of fraud in loan transactions. These words are not considered risky sellers if they are accompanied by words like: “home,” “construction,” “villas,” “houses,” “estates, “village” or “communities.” This demonstrates that construction companies that are limited liability companies are very rarely the perpetrators of fraud and often sell many homes. The home has been purchased twice in the last two years. As depicted in FIG. 3a, the following is thus input into the algorithm:

RS, the risky seller binary variable is 0—the buyer and seller are not risky as depicted in element 52.

TS, the number of times the property has been sold in the past three years is 2 as depicted in element 54.

RF, the binary variable for a refinance loan is 0—it is not a refinance loan as depicted in element 56.

AO, the binary variable for absentee owner is 1—the borrower does not intend to occupy the property as depicted in element 58.

AVM, the automated valuation model's estimate of value is $56,000 as depicted in element 60.

EX, the binary variable when user-submitted value exceeds automated valuation model valuation is 1—the user-submitted value exceeds the automated valuation model value as depicted in element 62.

EX50, the binary variable when user-submitted value exceeds automated valuation model valuation by more than 50% is 0—the appraised value does not exceed the automated valuation model valuation by more than 50% as depicted in element 64.

NARM, the binary variable for a non-arm's length transfer is 0—the transaction appears to be arm's length between the buyer and seller as depicted in element 66.

AG, the age of the target property is 77 years as depicted in element 68.

LA, the loan amount is $48,800 as depicted in element 70.

US, the user-submitted value is $61,000 as depicted in element 72.

SF, the square footage of the target property is 2072 as depicted in element 74.

Then the equation would then be:

$$\begin{matrix}Logit = 0.534 * 0 ( Seller is an individual ) \\ + 0.637 * 2 ( The property has been sold twice in the \\ last 2 years ) \\ - 0.984 * 0 ( Loan is a purchase , not a refinancing ) \\ + 0.979 * 1 ( Borrower does not intend to occupy the \\ property ) \\ - 0.00000808 * 56000 ( The automated valuation model \\ valuation ) \\ + 1.278 * 1 ( The appraised value exceeds automated \\ valuation model valuation ) \\ + 1.301 * 0 ( The appraised value is only 9 \% above \\ automated valuation model valuation , not more \\ than 50 \% ) \\ + 0.907 * 0 ( The transfer appears to be arm ' s length ) \\ + 0.029 * 77 ( The age of the property in years ) \\ + 0.0000136 * 48800 ( The requested loan amount ) \\ + 109139 / 56000 ( A constant divided by the automated \\ valuation model valuation ) \\ + 0.653 * ( 1.09 ) \hat{} 2.25 ( The ratio of appraised value to \\ automated valuation model valuation to the \\ power of 2.25 ) \\ - 0.000596 * 2072 ( The property ’ s square footage ) \\ - 3.738\end{matrix}$$

$$Then \text{:}$$

$$\begin{matrix}Logit = 0.000 ( in element 76 ) \\ + 1.274 ( in element 78 ) \\ - 0.000 ( in element 80 ) \\ + 0.979 ( in element 82 ) \\ - 0.452 ( in element 84 ) \\ + 1.278 ( in element 86 ) \\ + 0.000 ( in element 88 ) \\ + 0.000 ( in element 90 ) \\ + 2.233 ( in element 92 ) \\ + 0.664 ( in element 94 ) \\ + 1.949 ( in element 96 ) \\ + 0.792 ( in element 96 ) \\ - 1.235 ( in element 98 ) \\ - 3.738 ( in element 100 )\end{matrix}$$

The sum of each of these is:

Logit=3.744 (in element 102)
Referring now to FIG. 3b, the loan quality score is then computed using the second equation above, such that:

$$\begin{matrix}Loan Quality Score = 500 - ( 33 * Logit ) ( in element 104 ) \\ = 500 - ( 33 * 3.774 ) \\ = 376 ( in element 106 )\end{matrix}$$

This results in a loan quality score of 376.

In another embodiment, a different algorithm is applied in the step depicted in element 44 of FIG. 2. This algorithm also utilizes several variables. One of these variables in this embodiment uses data based upon the percent of households in a predetermined geographic area in which the subject property is located. In this embodiment, the geographic area is the census tract. By using the census tract, the group of homes by which the subject property is judged is very narrow and thus very accurate. In alternative embodiments larger or smaller predetermined geographic areas may be used.

The variables used in this embodiment are as

| | | |
|---|---|---|
| 1 | PL | The percent of households in the census tract earning |
| | | less than a specified amount |
| 2 | TS | The number of times the property has been sold in the |
| | | last two years |
| 3 | RF | Whether the loan is a purchase or a refinance |
| 4 | AVM | An AVM valuation of the subject property |
| 5 | EX | A binary variable for when the user submitted value |
| | | exceeds the automated valuation |
| 6 | AG | The age of the subject property in years |
| 7 | LA | The requested loan amount |
| 8 | AVR | The ratio of the suggested appreciation, given by the |
| | | requested loan amount, to the average appreciation in |
| | | the median home price in the same zip code during the |
| | | period |

The algorithm in this embodiment also considers the ratio of user-submitted appreciation to the median appreciation in a predetermined geographic area during the same period. In this embodiment, the predetermined geographic area is a census tract. This ratio is known as the appreciation variance ratio or AVR. The following algorithm, used in this embodiment, has been found to be the best mode, given the data available currently. This algorithm is applied using the above-listed variables. The algorithm in this embodiment is as follows:

$$\begin{matrix}Logit = 0.077 * PL \\ + 1.022 * TS \\ - 1.174 * RF \\ - 0.00001452 * AVM \\ + 1.901 * EX \\ + 0.012 * AG \\ + 0.00002222 * LA \\ + 0.459 * AVR \\ - 5.007\end{matrix}$$

Where:

Logit is the natural logarithm of the odds ratio, namely p/(1−p), where P is the probability that the loan is fraudulent.

PL is the percent of households earning less than a specified amount. In this embodiment, this amount is $25,000 per year.

TS is the number of times the property has been sold in the past three years.

RF is a binary dummy variable for refinance loans. If the loan is a refinance, the binary variable is set to 1, otherwise it is set to 0.

AVM is the automated valuation model's estimate of value.

EX is the binary dummy variable when user-submitted value exceeds automated valuation model valuation. If the user-submitted value exceeds the automated valuation, this binary variable is set to 1, otherwise it is set to 0.

AG is the age of the target property.

LA is the loan amount.

AVR is the ratio of the appreciation in value, as given by the user, compared to the appreciation in value of the median home price in a predetermined geographic area. In this embodiment, a census tract is used, however alternative embodiments may use other predetermined geographic areas. Theoretically, this ratio should be one to one. The larger the disparity in suggested subject property appreciation in value over median home price appreciation in value, the more likely fraud is to be occurring. By using the census tract, the homes by which the subject property is judged is very narrow and thus very accurate. This variable has been shown to have a high correlation to fraud in that the user's suggested property value appreciation is one of the main ways in which loan fraud is carried out. This variable provides an accurate measure of that appreciation when considered in light of the median appreciation in the narrow range of properties surrounding the subject property.

Once the Logit is computed, as above, the loan quality score is computed, as depicted in element 46, by multiplying the Logit, as computed above, and a predetermined constant and then subtracting that result from another constant. In this embodiment, these two constants are determined by comparing scores produced using the present invention with scores produced for loans known to be fraudulent and using statistical analysis to derive the correct constants. In the preferred embodiment, the following equation is used to compute the loan quality score:
Loan Quality Score=500−(31*Logit)

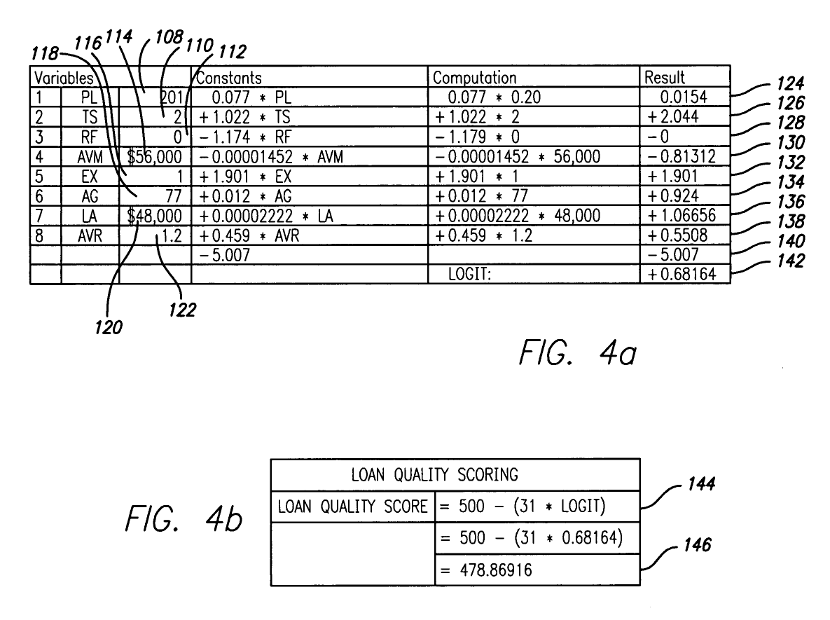

Referring now to FIG. 4a, using these equations, an example interaction is depicted. In this theoretical sale, a loan is requested by an individual Bill Buyer. An individual named Sally Seller is the home seller. The home is seventy-seven years old. The AVM valuation of that home is $56,000 and the requested loan amount is $48,800. This is a purchase and the buyer does not intend to live in the home after purchase. The appreciation variance ratio is 1.2. The home has been purchased twice in the last two years. As depicted in FIG. 4a, the following is thus input into the algorithm:

PL, the percent of household income below a certain number, in the preferred embodiment, $25,000 is 20% as depicted in element 108.

TS, the number of times the property has been sold in the past two years is 2 as depicted in element 110.

RF, the binary variable for a refinance loan is 0—it is not a refinance loan as depicted in element 112.

AVM, the automated valuation model's estimate of value is $56,000 as depicted in element 114.

EX, the binary variable when user-submitted value exceeds automated valuation model valuation is 1—the appraised valueexceeds the automated valuation model value as depicted in element 116.

AG, the age of the target property is 77 years as depicted in element 118.

LA, the loan amount is $48,800 as depicted in element 120.

AVR, the appreciation variance ratio is 1.2 as depicted in element 122.

$$\begin{matrix}Logit = 0.077 * 0.20 ( t he percent of households with less than \\ \$25 \text{,} 000 in income a year ) \\ + 1.022 * 2 ( the number of times the property sold in \\ the last two years ) \\ - 1.174 * 0 ( the loan is for a purchase ) \\ - 0.00001452 * 56 \text{,} 000 ( the automated valuation of \\ the property ) \\ + 1.901 * 1 ( the suggested value of the property exceeds \\ the automated valuation ) \\ + 0.012 * 77 ( the property is 77 years old ) \\ + 0.00002222 * 48 \text{,} 000 ( the requested loan amount ) \\ - 5.007\end{matrix}$$

$$Then \text{:}$$

$$\begin{matrix}Logit = 0.0154 ( in element 124 ) \\ + 2.044 ( in element 126 ) \\ - 0.000 ( in element 128 ) \\ - 0.81312 ( in element 130 ) \\ + 1.901 ( in element 132 ) \\ + 0.924 ( in element 134 ) \\ + 1.06656 ( in element 136 ) \\ + 0.5508 ( in element 138 ) \\ + 5.007 ( in element 140 )\end{matrix}$$

The sum of each of these is:

Logit=0.68164 (in element 142)
Referring now to FIG. 4b, the loan quality score is then computed using the second equation above, such that:

$$\begin{matrix}Loan Quality Score = 500 - ( 31 * Logit ) ( in element 144 ) \\ = 500 - ( 31 * 0.68164 ) \\ = 478.86916 ( in element 146 )\end{matrix}$$

This results in a loan quality score of approximately 479.

The next step in the preferred embodiment is to provide this score to the user as depicted in element 48. Alternative scores may be computed, particularly if the user is missing portions of the data required by either equation. If some data is missing, alternative equations will be used, dependant upon which portions of data are missing. These alternative embodiments are not ideal, but will be used as-necessary. Using one the above equations or an alternative equation a score between 0 and 1000 is computed. Using the above equation a lower and higher score than 0 and 1000 are possible, so boundaries are created such that if the scores are lower or higher than these lower and upper bounds, they are automatically set at those bounds. This score is provided to the user. A low score on this scale is a questionable loan. A low score would be a score from zero to 500. A marginal score would be a score from 500 to 550. In this range the loan is questionable, but not unsatisfactory. Finally, a score above 550 would be a satisfactory score. Receiving a particular score is not a predictor of fraud, but a method based on statistics of providing some indication of an increased likelihood for real estate loan fraud. Therefore, using the result from above, a loan quality score of 376, as depicted in the first embodiment is within the unsatisfactory range. A loan quality score of 479, as depicted in the second embodiment, is also within the unsatisfactory range. Therefore, the likelihood of fraud is high with both of these loan applications.

In the final step in the practice of this invention the following are provided: (1) a report including the score, (2) each of the user-inputted variables and their values, (3) other indicators of potential fraud and (4) neighboring sales data. These are provided in a report format as depicted in element 50. In the preferred embodiment, the user input is received via the Internet and the report is provided over the Internet. In some alternative embodiments, this step may not be completed, and the score alone may be provided. Alternatively, only portions of the report or portions of the data used to derive the report may be provided.

Accordingly, a method and apparatus for computing a loan quality score has been described. It is to be understood that the foregoing description has been made with respect to specific embodiments thereof for illustrative purposes only. The overall spirit and scope of the present invention is limited only by the following claims, as defined in the foregoing description.

What is claimed is:

1. A computer-based method of computing a loan quality score for a subject property comprising the steps of:
using past loan data to develop at least one algorithm for use in predicting loan fraud;
obtaining subject property data; and
applying said at least one algorithm to said subject property data to thereby compute a loan quality score.

2. A digital computer system programmed to perform the steps specified in the method of claim 1.

3. Computer-readable media containing programming designed to accomplish the method of claim 1.

4. The method of claim 1 wherein said past loan data includes at least one datum from a known fraudulent transaction.

5. The method of claim 1 wherein said subject property data includes a determination as to whether the seller is a risky seller based on a string search for key words.

7. The method of claim 1 wherein said subject property data includes the number of sales of said subject property within a predetermined period of time.

8. The method of claim 1 wherein said subject property data includes data to determine whether the loan purpose is for purchase or refinancing.

9. The method of claim 1 wherein said subject property data includes data to determine whether the borrower intends to occupy said subject property.

10. The method of claim 1 wherein said subject property data includes data to determine whether the sale appears to be an arm's length transfer.

11. The method of claim 1 wherein said subject property data includes the requested loan amount.

12. The method of claim 1 wherein said subject property data includes the age of said subject property.

13. The method of claim 1 wherein said subject property data includes the size of said subject property.

14. The method of claim 1 wherein said subject property data includes at least one automated valuation model valuation of said subject property.

15. The method of claim 1 wherein said subject property data includes an appreciation variance ratio.

16. The method of claim 1 wherein said subject property data includes at least one user-submitted value of said subject property.

17. The method of claim 1, wherein said algorithm is:
Loan quality score=500−(33*Logit)
Where:
$$\begin{matrix}Logit = 0.534 * RS \\ + 0.637 * TS \\ - 0.984 * RF \\ + 0.979 * AO \\ - 0.00000808 * AVM \\ + 1.278 * EX \\ + 1.301 * EX 50 \\ + 0.907 * NARM \\ + 0.029 * AG \\ + 0.0000136 * LA \\ + US / AVM \\ + 0.653 * ( AV / AEST ) \hat{} 2.25 \\ - 0.000596 * SF \\ - 3.738\end{matrix}$$
Where:
Logit is the natural logarithm of the odds ratio, namely p/(1−p), where P is the probability that the loan is fraudulent.
RS is the risky seller binary variable.
TS is the number of times the property has been sold in the past three years.
RF is a binary variable for refinance loans.
AO is a binary variable for absentee owner.
AVM is the automated valuation model's estimate of value.
EX is the binary variable when user-submitted value exceeds automated valuation model valuation.
EX50 is the binary variable when user-submitted value exceeds automated valuation model valuation by 50% or more.
NARM is the binary variable for a non-arm's length transfer.
AG is the age of the target property.
LA is the loan amount.
AV is the appraised value.
US is the user-submitted value.
SF is the square footage of the target property.

18. The method of claim 1, wherein said algorithm is:
Loan quality score=500−(31*Logit)
Where:
$$\begin{matrix}Logit = 0.077 * PL \\ + 1.022 * TS \\ - 1.174 * RF \\ - 0.00001452 * AVM \\ + 1.901 * EX \\ + 0.012 * AG \\ + 0.00002222 * LA \\ + 0.459 * AVR \\ - 5.007\end{matrix}$$
Where:
Logit is the natural logarithm of the odds ratio, namely p/(1−p), where P is the probability that the loan is fraudulent;
PL is the percent of households earning less than a specified amount;
TS is the number of times the property has been sold in the past three years.
RF is a binary dummy variable for refinance loans-If the loan is a refinance, the binary variable is set to 1, otherwise it is set to 0;
AVM is the automated valuation model's estimate of value.
EX is the binary dummy variable when user-submitted value exceeds automated valuation model valuation;
AG is the age of the target property;
LA is the loan amount; and
AVR is the ratio of the appreciation in value, as given by the user, compared to the appreciation in value of the median home price in the predetermined geographic area.

19. A method to be performed by a computer of determining a loan quality score for a subject property comprising the steps of:
using past loan data to develop at least one algorithm for use in predicting loan fraud;
obtaining subject property data;
obtaining an automated valuation model valuation of said subject property;
computing additional variables based upon said data and said automated valuation model valuation; and
applying said algorithm to said subject property data, said additional variables and said automated valuation model valuation to thereby compute a loan quality score.

20. A computer-based apparatus for computing a loan quality score for a subject property comprising:
input means for receiving subject property data
computation means connected to said input means for computing a loan quality score and for computing algorithms for use in providing said loan quality score; and
output means connected to said computation means for providing the results.

21. The apparatus of claim 20, further comprising:
automated valuation model connection means connected to said input means for requesting and receiving automated valuation model valuations.

22. The apparatus of claim 20, further comprising:
temporary data storage means connected to said computation means for storing said property data and said loan quality score.

23. The apparatus of claim 20, further comprising: report-generation means connected to said computation means for creating reports based upon said property data and said loan quality score.

24. The apparatus of claim 20, further comprising:
database connection means connected to said input means for requesting and receiving data from at least one database.

25. The apparatus of claim 20, wherein said computation means uses the algorithm:
Loan quality score=500−(33*Logit)
Where:
$$\begin{matrix}Logit = 0.534 * RS \\ + 0.637 * TS \\ - 0.984 * RF \\ + 0.979 * AO \\ - 0.00000808 * AVM \\ + 1.278 * EX \\ + 1.301 * EX 50 \\ + 0.907 * NARM \\ + 0.029 * AG \\ + 0.0000136 * LA \\ + US / AVM \\ + 0.653 * ( AV / AEST ) \hat{} 2.25 \\ - 0.000596 * SF \\ - 3.738\end{matrix}$$
Where:
Logit is the natural logarithm of the odds ratio, namely p/(1−p), where P is the probability that the loan is fraudulent.
RS is the risky seller binary variable.
TS is the number of times the property has been sold in the past three years.
RF is a binary variable for refinance loans.
AO is a binary variable for absentee owner.
AVM is the automated valuation model's estimate of value.
EX is the binary variable when user-submitted value exceeds automated valuation model valuation.
EX50 is the binary variable when user-submitted value exceeds automated valuation model valuation by 50% or more.
NARM is the binary variable for a non-arm's length transfer.
AG is the age of the target property.
LA is the loan amount.
AV is the appraised value.
US is the user-submitted value.
SF is the square footage of the target property.

26. The apparatus of claim 20, wherein said computation means uses the algorithm:
Loan quality score=500−(31*Logit)
Where:
$$\begin{matrix}Logit = 0.077 * PL \\ + 1.022 * TS \\ - 1.174 * RF \\ - 0.00001452 * AVM \\ + 1.901 * EX \\ + 0.012 * AG \\ + 0.00002222 * LA \\ + 0.459 * AVR \\ - 5.007\end{matrix}$$
Logit is the natural logarithm of the odds ratio, namely p/(1−p), where P is the probability that the loan is fraudulent;
PL is the percent of households earning less than a specified amount;
TS is the number of times the property has been sold in the past three years.
RF is a binary dummy variable for refinance loans-If the loan is a refinance, the binary variable is set to 1, otherwise it is set to 0;
AVM is the automated valuation model's estimate of value.
EX is the binary dummy variable when user-submitted value exceeds automated valuation model valuation;
AG is the age of the target property;
LA is the loan amount; and
AVR is the ratio of the appreciation in value, as given by the user, compared to the appreciation in value of the median home price in the predetermined geographic area.
